(19) United States
(12) Patent Application Publication
(10) Pub. No.: US 2022/0056202 A1
(43) Pub. Date: Feb. 24, 2022

(54) SUSTAINABLE POLYBUTYLENE TEREPHTHALATE COMPOSITIONS WITH IMPROVED COLOR CAPABILITY

(71) Applicant: SHPP GLOBAL TECHNOLOGIES B.V., Bergen op Zoom (NL)

(72) Inventors: Peter VOLLENBERG, Mt. Vernon, IN (US); Kaushal GANDHI, Mt. Vernon, IN (US); Lohith KENCHAIAH, Bangalore (IN); Gaurav MEDIRATTA, Bangalore (IN)

(21) Appl. No.: 17/421,190

(22) PCT Filed: Jan. 10, 2020
(86) PCT No.: PCT/IB2020/050190

§ 371 Date: Jul. 7, 2021

(30) Foreign Application Priority Data
Jan. 12, 2019 (IN) 201911001480

(51) Int. Cl. C08G 63/183; C08L 67/02; C08K 3/22; C08K 3/30

(52) U.S. Cl. CPC C08G 63/183; C08L 67/02; C08K 3/22; C08K 2003/3036; C08L 2207/20; C08K 2003/2241; C08K 3/30

(57) ABSTRACT

Thermoplastic compositions include from about 15 wt % to about 98 wt % of a polybutylene terephthalate (PBT) component, from about 2 wt % to about 10 wt % of at least one brightening agent and from 0 wt % to about 83 wt % of at least one additional component. The PBT component includes PBT derived from post-consumer or post-industrial recycled (PCR) polyethylene terephthalate (PET). In particular, the PBT may be derived from the PCR PET by first depolymerizing the PCR PET to form a high purity bis(2-hydroxyethyl) terephthalate (BHET) monomer (e.g., greater than 95% purity), and then polymerizing the high purity BHET monomer with butane diol (BDO) to form the PBT. The thermoplastic compositions have an L* color value of at least about 94.

### FIELD OF THE DISCLOSURE

The present disclosure relates to thermoplastic compositions, and in particular thermoplastic compositions including polybutylene terephthalate derived from post-consumer or post-industrial recycled polyethylene terephthalate.

### BACKGROUND OF THE DISCLOSURE

An injection molding material must satisfy many requirements to be suitable for consumer centric applications such as personal electronics. In certain applications, the material must be producible in a bright white color. Color is typically not a problem for petrochemical-based injection molded products (commonly referred to as “virgin” materials), but it can be difficult to achieve certain colors when the injection molded material includes post-consumer or post-industrial recycled (PCR) components, such as those derived from waste polyethylene terephthalate (PET). This presents a particular challenge with consumer electronics markets (among others) looking to incorporate “sustainable materials” in the products.

Thermoplastic compositions including from about 5 to 50 wt % post-consumer or post-industrial materials and that have suitable physical performance have been developed. However, the residual colorants or other contaminants in the PCR materials prevent these compositions from having certain colors, and in particular a bright white color.

These and other shortcomings are addressed by aspects of the disclosure.

### SUMMARY

Aspects of the disclosure relate to thermoplastic compositions including from about 15 wt % to about 98 wt % of a polybutylene terephthalate (PBT) component; from about 2 wt % to about 10 wt % of at least one brightening agent; and from 0 wt % to about 83 wt % of at least one additional component. The PBT component includes PBT derived from post-consumer or post-industrial recycled (PCR) polyethylene terephthalate (PET). The compositions have an L* color value of at least about 94.

Aspects of the disclosure further relate to methods for forming a thermoplastic composition, including: polymerizing a high purity bis(2-hydroxyethyl) terephthalate (BHET) monomer with butane diol (BDO) to form polybutylene terephthalate (PBT); and combining from about 15 wt % to about 98 wt % of the PBT, from about 2 wt % to about 10 wt % of at least one brightening agent, and from 0 wt % to about 83 wt % of at least one additional component to form the thermoplastic composition. The high purity BHET monomer is formed by depolymerizing post-consumer or post-industrial recycled (PCR) polyethylene terephthalate (PET).

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a process flow diagram showing a conventional process for forming polybutylene terephthalate using PCR PET as a precursor component.

FIG. 2 is a process flow diagram showing a process for forming polybutylene terephthalate according to aspects of the disclosure.

### DETAILED DESCRIPTION

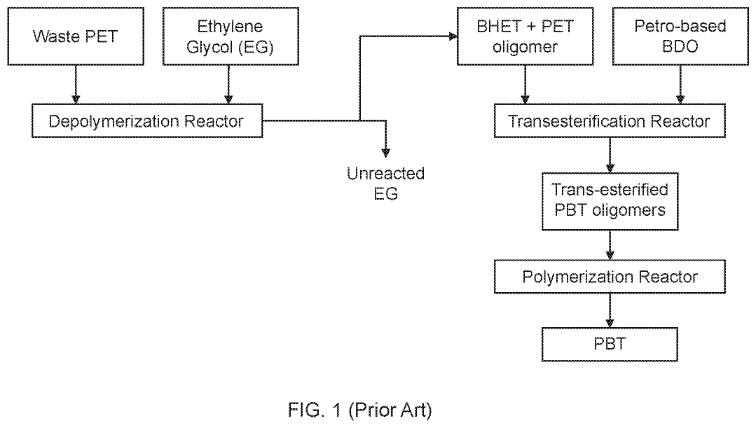

Aspects of the disclosure include thermoplastic compositions including polybutylene terephthalate (PBT) polymers derived from post-consumer or post-industrial recycle based components. Such PBT polymers may be referred to as “up-cycled” polymers. In such processes the post-consumer or post-industrial recycled (collectively referred to herein as “PCR”) polyethylene terephthalate (PET) is depolymerized to monomers such as the terephthalate-containing monomer bis(2-hydroxyethyl) terephthalate (BHET) and ethylene glycol (EG). Subsequently, the BHET is polymerized with butane diol (BDO) to form the PBT. An exemplary conventional process for forming PBT from PCR PET is shown in FIG. 1. As shown, waste PET is combined with ethylene glycol (EG) in a depolymerization reactor operating at, e.g., 230 degrees Celsius (° C.) and a pressure of 3.5 bar. The resulting oligomer product includes BHET, EG and PET monomers. This product is combined with BDO in a transesterification reactor operating at, e.g., 230-245° C. and under a 500 millibar (mbar) vacuum to form a trans-esterified PBT oligomer product; EG is distilled out during transesterification. The trans-esterified PBT oligomer product is then polymerized in a polymerization reactor operating at, e.g., <1 mbar to form the PBT.

The PBT formed from this conventional process may have acceptable physical performance characteristics, but it has not been able to be produced in a bright white color, as measured by an L* of greater than 94 determined according to the CIELab (International Commission on Illumination) color space. That deficiency is addressed by aspects of the present disclosure.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### DEFINITIONS

It is also to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to a composition including “a filler” includes compositions having two or more fillers.

As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

As used herein, “polybutylene terephthalate” (PBT) can be used interchangeably with poly(l,4-butylene terephthalate). PBT is a type of polyester, and has a structure represented by the formula:

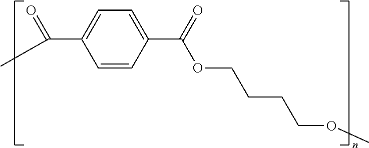

As used herein, “polyethylene terephthalate” (PET) can be used interchangeably with poly(ethyl benzene-1,4-dicarboxylate). As with PBT, polyethylene terephthalate is a type of polyester and has a structure represented by the formula:

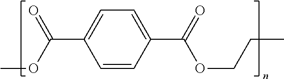

The terms “BisA,” “BPA,” or “bisphenol A,” which can be used interchangeably, as used herein refers to a compound having a structure represented by the formula:

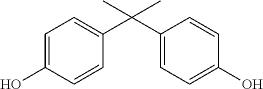 [SMILES: CC(C)(c1ccc(O)cc1)c1ccc(O)cc1]

BisA can also be referred to by the name 4,4′-(propane-2,2-diyl)diphenol; p,p′-isopropylidenebisphenol; or 2,2-bis(4-hydroxyphenyl)propane. BisA has the CAS #80-05-7.

As used herein, “polycarbonate” refers to an oligomer or polymer comprising residues of one or more dihydroxy compounds, e.g., dihydroxy aromatic compounds, joined by carbonate linkages; it also encompasses homopolycarbonates, copolycarbonates, and (co)polyester carbonates.

The terms “residues” and “structural units”, used in reference to the constituents of the polymers, are synonymous throughout the specification.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### Thermoplastic Compositions

Aspects of the disclosure related to thermoplastic compositions including: from about 15 wt % to about 98 wt % of a polybutylene terephthalate (PBT) component; from about 2 wt % to about 10 wt % of at least one brightening agent; and from 0 wt % to about 83 wt % of at least one additional component. The PBT component includes PBT derived from post-consumer or post-industrial recycled (PCR) polyethylene terephthalate (PET). In certain aspects the thermoplastic composition has an L* color value of at least about 94. In other aspects the thermoplastic composition has an L* color value of at least about 96, or an L* color value of at least about 97.

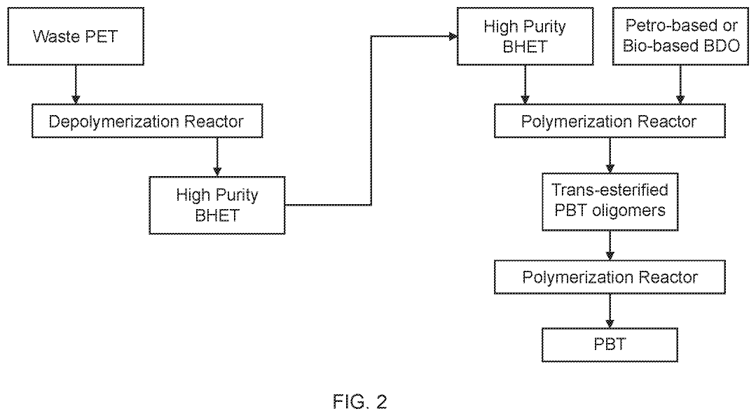

In some aspects the PBT component includes PBT derived from PCR PET by first depolymerizing the PCR PET to form a high purity bis(2-hydroxyethyl) terephthalate (BHET) monomer, and then polymerizing the high purity BHET monomer with butane diol (BDO) to form the PBT. This process may be performed in accordance with that described above and with reference to FIG. 2. BHET has a structure represented by the formula:

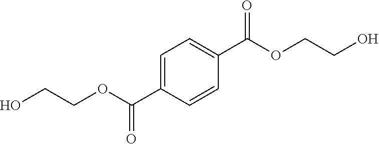 [SMILES: O=C(OCCO)c1ccc(C(=O)OCCO)cc1]

In particular aspects, the high purity BHET monomer has a purity of at least about 95%. This is in contrast to conventional methods for making PBT from PCR PET in which the BHET monomer had a purity of less than 80% or even less than 40%. It has been found that by using a high purity BHET monomer derived from PCR PET to form the PBT, a PBT composition having a bright white color (L* value greater than 94 such as greater than 96 or greater than 97) can be formed.

While in the conventional process the BDO is petroleum-based, in certain aspects of the disclosure the BDO may be bio-based. Bio-based BDO does not include residual colorants and impurities such as those found in PCR PET moieties, so it is believed that no effect on color would be observed when substituting bio-based BDO for petroleum-based BDO. Butane diol has a structure represented by the formula:

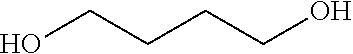

The thermoplastic composition may include from about 15 wt % to about 98 wt % of the PBT component. In some aspects the thermoplastic composition includes from about 15 wt % to about 90 wt % of the PBT component, or from about 15 wt % to about 50 wt % of the PBT component, or from about 15 wt % to about 60 wt % of the PBT component, or from about 15 wt % to about 30 wt % of the PBT component, or from about 15 wt % to about 25 wt % of the PBT component.

Any suitable brightening agent may be used. In particular aspects the at least one brightening agent includes titanium dioxide (TiO₂), zinc sulfide (ZnS), or a combination thereof The composition may include from about 2 wt % to about 10 wt % of the at least one brightening agent, or in particular aspects from about 2 wt % to about 5 wt % of the at least one brightening agent.

In certain aspects the thermoplastic composition further includes a fluorescent whitening agent, which can contribute to the composition having further improved color properties. Any suitable fluorescent whitening agent may be used; one particular example is Eastobrite™ OB-1, available from Eastman. The fluorescent whitening agent, if included, may have a content of from greater than 0 wt % to about 0.5 wt % in the composition in some aspects.

The thermoplastic composition further includes from 0 wt % to about 83 wt % of at least one additional component. The at least one additional component may include, but is not limited to, an additional thermoplastic polymer (e.g., polycarbonate and copolymers thereof), a filler, an impact modifier, a pigment, a whitening agent, a surfactant, a processing aid, a thermal stabilizer, a flame retardant, a photochemical stabilizer or a combination thereof. In particular aspects the thermoplastic composition includes one or more of the following additional components: from greater than 0 wt % to about 45 wt % polycarbonate (e.g., bisphenol A polycarbonate); from greater than 0 wt % to about 35 wt % filler (e.g., glass fiber); from greater than 0 wt % to about 30 wt % of a polycarbonate copolymer; from greater than 0 wt % to about 15 wt % of an impact modifier; and from greater than 0 wt % to about 10 wt % of a flame retardant.

### Methods for Forming Thermoplastic Compositions

Aspects of the disclosure further relate to methods for forming a thermoplastic composition, the method including:

polymerizing a high purity bis(2-hydroxyethyl) terephthalate (BHET) monomer with butane diol (BDO) to form polybutylene terephthalate (PBT); and

combining
from about 15 wt % to about 98 wt % of the PBT,
from about 2 wt % to about 10 wt % of at least one brightening agent, and
from 0 wt % to about 83 wt % of at least one additional component,

to form the thermoplastic composition.

The high purity BHET monomer is formed by depolymerizing post-consumer or post-industrial recycled (PCR) polyethylene terephthalate (PET) according to the aspects described herein.

The thermoplastic composition formed according to the method may include any of the components and in any of the amounts described herein.

### Articles of Manufacture

In certain aspects, the present disclosure pertains to shaped, formed, or molded articles including the thermoplastic compositions described herein. The thermoplastic compositions can be molded into useful shaped articles by a variety of means such as injection molding, extrusion, rotational molding, blow molding and thermoforming to form articles, structural components or functional components of, for example, personal or commercial electronics devices, including but not limited to cellular telephones, tablet computers, personal computers, notebook and portable computers, and other such equipment, medical applications, RFID applications, automotive applications, and the like.

Various combinations of elements of this disclosure are encompassed by this disclosure, e.g., combinations of elements from dependent claims that depend upon the same independent claim.

### Aspects of the Disclosure

In various aspects, the present disclosure pertains to and includes at least the following aspects.

Aspect 1. A thermoplastic composition comprising:

from about 15 wt % to about 98 wt % of a polybutylene terephthalate (PBT) component;

from about 2 wt % to about 10 wt % of at least one brightening agent; and

from 0 wt % to about 83 wt % of at least one additional component,

wherein the PBT component comprises PBT derived from post-consumer or post-industrial recycled (PCR) polyethylene terephthalate (PET), and wherein the thermoplastic composition has an L* color value of at least about 94.

Aspect 2. The thermoplastic composition according to Aspect 1, wherein the PBT is derived from PCR PET by first depolymerizing the PCR PET to form a high purity bis(2-hydroxyethyl) terephthalate (BHET) monomer, and then polymerizing the high purity BHET monomer with butane diol (BDO) to form the PBT.

Aspect 3. The thermoplastic composition according to Aspect 2, wherein the high purity BHET monomer has a purity of at least about 95%.

Aspect 4. The thermoplastic composition according to any of Aspects 1 to 3, wherein the at least one brightening agent comprises titanium dioxide (TiO₂), zinc sulfide (ZnS), or a combination thereof

Aspect 5. The thermoplastic composition according to any of Aspects 1 to 4, wherein the thermoplastic composition further comprises from greater than 0 wt % to about 0.5 wt % of a fluorescent whitening agent.

Aspect 6. The thermoplastic composition according to any of Aspects 1 to 5, wherein the composition comprises from about 2 wt % to about 5 wt % of the at least one brightening agent.

Aspect 7. The thermoplastic composition according to any of Aspects 1 to 6, further comprising at least one additional component comprising an additional thermoplastic polymer, a filler, an impact modifier, a pigment, a whitening agent, a surfactant, a processing aid, a thermal stabilizer, a flame retardant, a photochemical stabilizer or a combination thereof.

Aspect 8. The thermoplastic composition according to any of Aspects 1 to 7, wherein the composition comprises from about 15 wt % to about 60 wt % of the PBT component, and wherein the composition has an L* color value of at least about 96.

Aspect 9. The thermoplastic composition according to any of Aspects 1 to 8, wherein the composition comprises from about 15 wt % to about 30 wt % of the PBT component, and wherein the composition has an L* color value of at least about 97.

Aspect 10. A method for forming a thermoplastic composition, comprising:

polymerizing a high purity bis(2-hydroxyethyl) terephthalate (BHET) monomer with butane diol (BDO) to form polybutylene terephthalate (PBT); and

combining
from about 15 wt % to about 98 wt % of the PBT,
from about 2 wt % to about 10 wt % of at least one brightening agent, and
from 0 wt % to about 83 wt % of at least one additional component,

to form the thermoplastic composition,

wherein the high purity BHET monomer is formed by depolymerizing post-consumer or post-industrial recycled (PCR) polyethylene terephthalate (PET).

Aspect 11. The method according to Aspect 10, wherein the thermoplastic composition has an L* color value of at least about 94.

Aspect 12. The method according to Aspect 10 or 11, wherein the high purity BHET monomer has a purity of at least about 95%.

Aspect 13. The method according to any of Aspects 10 to 12, wherein the at least one brightening agent comprises titanium dioxide (TiO₂), zinc sulfide (ZnS), or a combination thereof.

Aspect 14. The method according to any of Aspects 10 to 13, wherein the PBT and at least one brightening agent are further combined with from greater than 0 wt % to about 0.5 wt % of a fluorescent whitening agent.

Aspect 15. The method according to any of Aspects 10 to 14, wherein the composition comprises from about 2 wt % to about 5 wt % of the at least one brightening agent.

Aspect 16. The method according to any of Aspects 10 to 15, wherein the composition comprises from about 50 wt % to about 98 wt % of the PBT component.

Aspect 17. The method according to any of Aspects 10 to 15, wherein the composition comprises from about 15 wt % to about 60 wt % of the PBT component, and wherein the composition has an L* color value of at least about 96.

Aspect 18. The method according to any of Aspects 10 to 15, wherein the composition comprises from about 15 wt % to about 30 wt % of the PBT component, and wherein the composition has an L* color value of at least about 97.

Aspect 19. The method according to any of Aspects 10 to 18, wherein the BDO is derived from a petroleum source or a bio-based source.

Aspect 20. The method according to any of Aspects 10 to 19, further comprising at least one additional component comprising an additional thermoplastic polymer, a filler, an impact modifier, a pigment, a whitening agent, a surfactant, a processing aid, a thermal stabilizer, a flame retardant, a photochemical stabilizer or a combination thereof

Aspect 21. A thermoplastic composition formed according to the method of any of Aspects 10 to 20.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Several PBT-based thermoplastic compositions were prepared and tested. The compositions are listed in Table 1, and included four comparative compositions (C1.1-C1.4) and one composition prepared in accordance with aspects of the disclosure (Exl). Composition C1.1 included virgin PBT (Valox™ 195, SABIC) as the primary component. The composition of C1.1 corresponds to Valox™ 325 (SABIC), a commercial grade of PBT that is known to have a bright white color. About 4 wt % titanium dioxide was added as a brightening agent to each of the compositions, which also included a fluorescent whitener (Eastman Eastobrite OB-1) and a small amount of blue pigment. Each of the compositions also included 10 wt % virgin PBT (Valox™ 315, SABIC), which has a different viscosity than the base PBT resin, allowing for control over the rheological behavior of the composition.

The source of the base PBT resin in each composition was as follows:
C1.1 Virgin PBT from petrochemical feedstock (Valox™ 195 PBT resin).
C1.2 Derived from BHET monomer produced from PCR PET; the BHET monomer had a purity of 60-80%.
C1.3 Derived from BHET monomer produced from PCR PET; the BHET monomer had a purity of 30-36%.
C1.4 Derived from BHET monomer produced from PCR PET; the BHET monomer had a purity of 60-80%.
Ex1. Derived from BHET monomer produced from PCR PET; the BHET monomer had a purity of greater than 95%.

In each of the compositions formed from the BHET monomer, the butane diol (BDO) was derived from a petroleum source. The compositions and their color properties are shown in Table 1:

TABLE 1
Compositions and Color Properties

| | C1.1 | C1.2 | C1.3 | C1.4 | Ex1 |
|---|---|---|---|---|---|
| | | PCR PET | PCR PET | PCR PET | PCR PET |
| | Virgin | (BHET process, | (BHET process, | (BHET process, | (BHET process, |
| PBT Source | PBT | 60-80% purity) | 30-36% purity) | 60-80% purity | > 95% purity) |
| Component | | | | | |
| (wt %) | | | | | |
| PBT | 85.339 | 85.339 | 85.339 | 85.339 | 85.339 |
| Virgin PBT | 10 | 10 | 10 | 10 | 10 |
| Hydrocarbon wax | 0.2 | 0.2 | 0.2 | 0.2 | 0.2 |
| release | | | | | |
| Hindered phenol | 0.06 | 0.06 | 0.06 | 0.06 | 0.06 |
| stabilizer | | | | | |
| Titanium dioxide | 4.3 | 4.3 | 4.3 | 4.3 | 4.3 |
| Fluorescent | 0.1 | 0.1 | 0.1 | 0.1 | 0.1 |
| whitener* | | | | | |
| Pigment Blue 28 | 0.001 | 0.001 | 0.001 | 0.001 | 0.001 |
| Total (wt %) | 100 | 100 | 100 | 100 | 100 |
| CIELab | | | | | |
| properties (PBT) | | | | | |
| L* | 87.6 | 73.3 | 73.6 | 82.0 | 80.9 |
| a* | −1.1 | −0.2 | −0.3 | −0.4 | −0.7 |
| b* | 0.0 | 0.5 | 0.7 | −2.0 | 0.4 |
| CIELab | | | | | |
| properties | | | | | |
| (composition) | | | | | |
| L* | 96.2 | 92.3 | 91.6 | 93.3 | 94.8 |
| a* | 2.1 | 1.6 | 1.6 | 1.7 | 1.7 |
| b* | −9.8 | −10.0 | −9.8 | −11.0 | −10.5 |
| Δ L* vs. C1.1 | — | −3.9 | −4.6 | −2.9 | −1.4 |
| Δ a* vs. C1.1 | — | −0.5 | −0.5 | −0.5 | −0.4 |
| Δ b* vs. C1.1 | — | −0.2 | 0.0 | −1.2 | −0.6 |

*Eastman Eastobrite OB-1

Diffuse reflectance measurements were acquired on an X-Rite Spectrophotometer with D65 illumination, a 10 degree observer, with the CIE L*, a*, b*, specular component included, the UV component included, a large lens position, and a large aperture.

As observed in Table 1, it is observed that the virgin PBT base material in C1.1 has excellent base color, as evidenced by an L* value around 87. The base color of the other PBT resins is substantially lower with L* values ranging between 73 and 82.

The color properties of each of the compositions were also determined. Unsurprisingly, C1.1 which includes PBT having a high L* value had an excellent L* value of about 96. It was also observed that the L* values of C1.2, C1.3 and C1.4, which include PBT resin having a lower L* value, all had an L* value of less than 94.

Unexpectedly, however, the composition including PBT with an L* value of only 80.9 (Ex1) had a high L* value greater than 94, comparable to that of the composition including virgin PBT (C1.1). As noted, the composition of Exl included PBT derived from the high purity (>95%) BHET monomer.

Certain physical and rheological properties of the compositions were also determined; results are shown in Table 2:

TABLE 2
Physical and Rheological Properties

| Test Description | Unit | C1.1 | C1.2 | C1.3 | C1.4 | Ex1 |
|---|---|---|---|---|---|---|
| MVR, ASTM D 1238, 250° C., | cm³/10 min | 47 | 56 | 41 | 59 | 36 |
| 1.2 Kg, 360 s dwell time | | | | | | |
| MVR, ASTM D 1238, 250° C., | cm³/10 min | 51 | 63 | 47 | 68 | 41 |
| 1.2 Kg, 1080 s dwell time | | | | | | |
| Tensile test-ASTM D638, | | | | | | |
| 50 mm/min, 23° C. | | | | | | |
| Modulus of Elasticity | MPa | 2626 | 2554 | 2544 | 2502 | 2562 |
| Tensile Strength at Break | MPa | 59 | 57 | 51 | 52 | 47 |
| % Elongation at Break | % | 8 | 8 | 14 | 6 | 20 |
| Notched Izod Impact-ASTM | | | | | | |
| D256, 23° C. | | | | | | |
| Ductility | % | 0 | 0 | 0 | 0 | 0 |
| Impact Strength | J/m | 31 | 30 | 31 | 31 | 33 |
| HDT-ASTM D648 | MPa | 1.82 | 1.82 | 1.82 | 1.82 | 1.82 |
| Thickness | mm | 3.175 | 3.175 | 3.2 | 3.2 | 3.175 |
| Deflection temp | ° C. | 55 | 51 | 51 | 51 | 52 |
| DSC following the global | | | | | | |
| method, 20° C./min | | | | | | |
| Onset Melting Temp (Tm) | ° C. | 225 | 218 | 219 | 219 | 222 |
| Heat of Fusion/Melting | J/g | 48 | 45 | 46 | 47 | 49 |
| (ΔHf) | | | | | | |
| Onset Crystallization Temp | ° C. | 197 | 188 | 187 | 186 | 193 |
| (Tc) | | | | | | |
| Heat of Crystallization | J/g | −49.5 | −43.8 | −45.3 | −45 | −46.9 |
| (ΔHc) | | | | | | |
| Peak Melting Temp (Tpm) | ° C. | 224.4 | 218 | 218.6 | 218.2 | 221.4 |
| Melt State Rheology, 250° C., | — | PBT | PBT | PBT | PBT | PBT |
| 1800 s duration | | | | | | |
| Viscosity Change | % | 92 | 111 | 88 | 68 | 93 |
| Melt Viscosity (MV)- | | | | | | |
| ISO11443 | | | | | | |
| App. shear rate-Ind | 1/s | 640 | 640 | 640 | 640 | 640 |
| App. viscosity-Ind | Pa · s | 99 | 83 | 113 | 81 | 126 |

From the data it was observed that although there were some slight differences in the properties of Exl compared to that derived from virgin PBT (C1.1), there were no significant issues that would prevent the composition of Exl from being applicable in typical consumer electronics type applications. The results described herein thus demonstrate the suitability of compositions including PBT derived from recycled PET.

Additional example and comparative compositions were prepared as set forth in Table 3.1 below:

TABLE 3.1
Compositions

| Item Description | Unit | C3.1 | C3.2 | Ex3.1 | Ex3.2 | Ex3.3 | Ex3.4 |
|---|---|---|---|---|---|---|---|
| Polycalbonate 100 Grade | % | 52.249 | 29.849 | 52.249 | 29.849 | 52.249 | 29.849 |
| PC-siloxane copolymer (20% Si | % | 20 | 30 | 20 | 30 | 20 | 30 |
| content), PCP endcapped | | | | | | | |
| Virgin PBT 315 | % | 15 | 25 | | | | |
| PCR PBT (from PCR PET, | % | | | 15 | 25 | | |
| BHET process, 60-80% purity) | | | | | | | |
| PCT PBT (from PCR PET, | % | | | | | 15 | 25 |
| BHET process and std | | | | | | | |
| BDO, >95% purity) | | | | | | | |
| Bisphenol A bis(diphenyl | % | 7.5 | 9.5 | 7.5 | 9.5 | 7.5 | 9.5 |
| phosphate) | | | | | | | |
| SAN encapsulated PTFE- | % | 0.6 | 1 | 0.6 | 1 | 0.6 | 1 |
| intermediate resin | | | | | | | |
| Hindered phenol anti-oxidant | % | 0.3 | 0.3 | 0.3 | 0.3 | 0.3 | 0.3 |
| Hindered phenol stabilizer | % | 0.15 | 0.15 | 0.15 | 0.15 | 0.15 | 0.15 |
| Mono zinc phosphate (MZP) | % | 0.1 | 0.1 | 0.1 | 0.1 | 0.1 | 0.1 |
| Coated TiO₂ | % | 4 | 4 | 4 | 4 | 4 | 4 |
| Fluorescent whitener (Eastman | % | 0.1 | 0.1 | 0.1 | 0.1 | 0.1 | 0.1 |
| Eastobrite OB-1, pulverized) | | | | | | | |
| Pigment Blue 28 | % | 0.001 | 0.001 | 0.001 | 0.001 | 0.001 | 0.001 |
| Total: | % | 100 | 100 | 100 | 100 | 100 | 100 |

The color properties of the compositions of Table 3.1 are set forth in Table 3.2:

TABLE 3.2
Color Properties

| L-a-b Color Indices and | | | | | | |
|---|---|---|---|---|---|---|
| Yellowness Index | C3.1 | C3.2 | Ex3.1 | Ex3.2 | Ex3.3 | Ex3.4 |
| L*-Avg | 97.7 | 97.4 | 96.7 | 96.0 | 97.6 | 97.0 |
| a*-Avg | 1.3 | 1.2 | 1.1 | 1.1 | 1.2 | 1.1 |
| b*-Avg | −7.3 | −6.7 | −7.4 | −7.0 | −7.7 | −7.2 |

As observed from the data, example compositions Ex3.3 and Ex3.4 formed from the high purity BHET monomer have an L* color value that is very close to that of the compositions formed from virgin PBT (C3.1 and C3.2). For those skilled in the art, a difference of less than 0.5 L* units is considered very close.

Physical and rheological properties of the compositions of Table 3.1 are provided in Table 3.3:

TABLE 3.3
Physical and Rheological Properties

| | | C3.1 | C3.2 | Ex3.1 | Ex3.2 | Ex3.3 | Ex3.4 |
|---|---|---|---|---|---|---|---|
| Tensile test-ASTM D 638, Uniaxial | | | | | | | |
| tensile test, 50 mm/min speed, 23° C. | | | | | | | |
| Modulus of Elasticity-Avg | MPa | 2608 | 2570 | 2644 | 2566 | 2563 | 2558 |
| Tensile Strength at Yield-Avg | MPa | 64.3 | 62.3 | 64.6 | 62.2 | 64.6 | 61.8 |
| Tensile Strength at Break-Avg | MPa | 49.7 | 42.7 | 49.1 | 37.3 | 49.0 | 41.1 |
| % Elongation at Yield-Avg | % | 4.3 | 4.0 | 4.3 | 3.9 | 4.3 | 4.0 |
| % Elongation at Break-Avg | % | 123 | 130 | 95 | 92 | 99 | 74 |
| Notched Izod Impact-ASTM D256, | | | | | | | |
| ASTM D4812, 23° C., 2.75 J | | | | | | | |
| pendulum energy | | | | | | | |
| Ductility | % | 100 | 100 | 100 | 100 | 100 | 100 |
| Impact Strength-Avg | J/m | 541 | 328 | 596 | 342 | 687 | 355 |
| Notched Izod Impact-ASTM D256, | | | | | | | |
| ASTM D4812, 0° C., 2.75 J | | | | | | | |
| Ductility | % | 0 | 0 | 0 | 0 | 100 | 0 |
| Impact Strength-Avg | J/m | 121 | 98 | 135 | 105 | 524 | 108 |
| Heat deflection temperature (HDT)- | | | | | | | |
| ASTM D 648, 1.82 MPa | | | | | | | |
| Sample thickness | mm | 3.143 | 3.156 | 3.143 | 3.181 | 3.149 | 3.155 |
| Deflection temp-Avg | ° C. | 77 | 73 | 75 | 72 | 83 | 73 |
| Melt Volume-flow Rate (MVR), | cm³/10 | 20 | 19 | 19 | 20 | 17 | 18 |
| ASTM D 1238 according to Global | min | | | | | | |
| Test Method, 260° C., 5 Kg, 360 s | | | | | | | |
| dwell time | | | | | | | |
| Melt Volume-flow Rate (MVR), | cm³/10 | 23 | 22 | 22 | 23 | 19 | 20 |
| ASTM D 1238 according to Global | min | | | | | | |
| Test Method, 260° C., 5 Kg load, | | | | | | | |
| 1080 s dwell time | | | | | | | |
| DSC following the global method, | | | | | | | |
| 40° C. start temp, 290° C. end temp, | | | | | | | |
| 20° C./min ramp rate | | | | | | | |
| Onset Melting Temp (Tm) | ° C. | 222 | 220 | 212 | 213 | 218 | 219 |
| Heat of Fusion/Melting (ΔHf) | J/g | 8.0 | 10.5 | 8.9 | 12.8 | 8.9 | 11.6 |
| Onset Crystallization | ° C. | 100 | 102 | 90 | 94 | 98 | 100 |
| Temp (Tc) | | | | | | | |
| Heat of Crystallization (ΔHc) | J/g | −3.2 | −4.5 | −1.2 | −1.8 | −2.3 | −1.9 |
| Peak Melting Temp (Tpm) | ° C. | 220 | 219 | 211 | 210 | 217 | 216 |
| UL94 flame tests (V0, V1, V2) | | | | | | | |
| Total Flame Time (23° C., 48 Hr, | s | 15 | 60 | 16 | 112 | 31 | 99 |
| 1.5 mm sample thickness, white | | | | | | | |
| color) | | | | | | | |
| Total Flame Time (70° C., 168 | s | 5 | 77 | 16 | 54 | 21 | 76 |
| Hr, 1.5 mm sample thickness, | | | | | | | |
| white color) | | | | | | | |
| Rating | | V-0 | V-1 | V-0 | V-Not | V-0 | V-1 |

As observed from the data, the temperature properties (Tm, Tc and Tpm) of the example compositions including PCT PBT formed from high purity PCR PET (Ex3.3 and Ex3.4) are much closer to those formed with virgin PBT (C3.1 and C3.2) as compared to the compositions including PCT PBT formed from a lower purity PCR PET (Ex3.1 and Ex3.2).

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A thermoplastic composition comprising:
from about 15 wt % to about 98 wt % of a polybutylene terephthalate (PBT) component;
from about 2 wt % to about 10 wt % of at least one brightening agent; and
from 0 wt % to about 83 wt % of at least one additional component, wherein the PBT component comprises PBT derived from post-consumer or post-industrial recycled (PCR) polyethylene terephthalate (PET), and wherein the thermoplastic composition has an L* color value of at least about 94.

2. The thermoplastic composition according to claim 1, wherein the PBT is derived from PCR PET by first depolymerizing the PCR PET to form a high purity bis(2-hydroxyethyl) terephthalate (BHET) monomer, and then polymerizing the high purity BHET monomer with butane diol (BDO) to form the PBT.

3. The thermoplastic composition according to claim 2, wherein the high purity BHET monomer has a purity of at least about 95%.

4. The thermoplastic composition according to claim 1, wherein the at least one brightening agent comprises titanium dioxide (TiO2), zinc sulfide (ZnS), or a combination thereof.

5. The thermoplastic composition according to claim 1, wherein the thermoplastic composition further comprises from greater than 0 wt % to about 0.5 wt % of a fluorescent whitening agent.

6. The thermoplastic composition according to claim 1, wherein the composition comprises from about 2 wt % to about 5 wt % of the at least one brightening agent.

7. The thermoplastic composition according to claim 1, further comprising at least one additional component comprising an additional thermoplastic polymer, a filler, an impact modifier, a pigment, a whitening agent, a surfactant, a processing aid, a thermal stabilizer, a flame retardant, a photochemical stabilizer or a combination thereof

8. The thermoplastic composition according to claim 1, wherein the composition comprises from about 15 wt % to about 60 wt % of the PBT component, and wherein the composition has an L* color value of at least about 96.

9. The thermoplastic composition according to claim 1, wherein the composition comprises from about 15 wt % to about 30 wt % of the PBT component, and wherein the composition has an L* color value of at least about 97.

10. A method for forming a thermoplastic composition, comprising:
polymerizing a high purity bis(2-hydroxyethyl) terephthalate (BHET) monomer with butane diol (BDO) to form polybutylene terephthalate (PBT); and
combining
from about 15 wt % to about 98 wt % of the PBT,
from about 2 wt % to about 10 wt % of at least one brightening agent, and
from 0 wt % to about 83 wt % of at least one additional component,
to form the thermoplastic composition,
wherein the high purity BHET monomer is formed by depolymerizing post-consumer or post-industrial recycled (PCR) polyethylene terephthalate (PET).

11. The method according to claim 10, wherein the thermoplastic composition has an L* color value of at least about 94.

12. The method according to claim 10, wherein the high purity BHET monomer has a purity of at least about 95%.

13. The method according to claim 10, wherein the composition comprises from about 15 wt % to about 60 wt % of the PBT component, and wherein the composition has an L* color value of at least about 96.

14. The method according to claim 10, wherein the BDO is derived from a petroleum source or a bio-based source.

15. A thermoplastic composition formed according to the method of claim 10.
